(19) United States
(12) Patent Application Publication
(10) Pub. No.: US 2014/0352324 A1
(43) Pub. Date: Dec. 4, 2014

(54) DUAL PRESSURE REGULATOR SHUT OFF VALVE APPARATUS

(71) Applicant: HAMILTON SUNSTRAND CORPORATION, Windsor Locks, CT (US)

(72) Inventors: Jeffry Ernst, Wethersfield, CT (US); John M. Maljaian, Farmington, CT (US)

(73) Assignee: HAMILTON SUNSTRAND CORPORATION, Windsor Locks, CT (US)

(21) Appl. No.: 13/904,659

(22) Filed: May 29, 2013

(51) Int. Cl. F02C 7/18; F02C 3/04

(52) U.S. Cl. CPC F02C 7/18; F02C 3/04
USPC 60/806; 165/282; 29/889.22

(57) ABSTRACT

A pre-cooler system is provided and includes first and second pre-coolers, each of which is sized to handle demands of one downstream flow system, a piping system by which the first and second pre-coolers are receptive of compressed air from first and second turbine engines, respectively, and by which the first and second pre-coolers are both coupled to first and second downstream flow systems that are each configured to apply the demands of one downstream flow system to the first and second pre-coolers, a first pair of dual pressure regulator shut off valves (PRSOVs) disposed in parallel with each other and between the first turbine engine and the first downstream flow system, the first pair of dual PRSOVs being arranged in series with the first pre-cooler and a second pair of dual PRSOVs disposed in parallel with each other and between the second turbine engine and the second downstream flow system, the second pair of dual PRSOVs being arranged in series with the second pre-cooler.

### BACKGROUND OF THE INVENTION

The subject matter disclosed herein relates to a dual pressure regulator shut off valve (PRSOV) apparatus and, more particularly, to a dual PRSOV apparatus to improve bleed dispatchability and weight for an aircraft.

An aircraft, such as a two-engine commercial jet, is dividable into left and right sides. Each side typically includes an engine, a downstream flow system, a pre-cooler and one pressure regulator shut off valve (PRSOV). For each side, the PRSOV is disposed between the engine and the downstream flow system. The PRSOV can be upstream or downstream of the pre-cooler. Compressed air is bled from the engine and passed to the downstream flow system through the PRSOV and the pre-cooler.

It is often the case that the largest contributor to bleed system weight is the pre-coolers on each side of the aircraft. However, since each side of the aircraft has only one PRSOV, each of the pre-coolers must be sized to handle the demands of the downstream flow systems of each side of the aircraft. This is because in a case of a failure of one of the PRSOVs, the pre-cooler associated with the operation of the functional PRSOV is required to be sized to handle and meet the demands of the downstream flow systems of both sides of the aircraft.

Since it is impossible to predict ahead of time that either of the PRSOVs of an aircraft will fail, it is necessary to design the bleed system with the assumption that either one of the PRSOVs will experience a failure. Thus, both pre-coolers must be sized to handle and meet the demands of the downstream flow systems of both sides of the aircraft.

### BRIEF DESCRIPTION OF THE INVENTION

According to one aspect of the invention, a pre-cooler system is provided and includes first and second pre-coolers, each of which is sized to handle demands of one downstream flow system, a piping system by which the first and second pre-coolers are receptive of compressed air from first and second turbine engines, respectively, and by which the first and second pre-coolers are both coupled to first and second downstream flow systems that are each configured to apply the demands of one downstream flow system to the first and second pre-coolers, a first pair of dual pressure regulator shut off valves (PRSOVs) disposed in parallel with each other and between the first turbine engine and the first downstream flow system, the first pair of dual PRSOVs being arranged in series with the first pre-cooler and a second pair of dual PRSOVs disposed in parallel with each other and between the second turbine engine and the second downstream flow system, the second pair of dual PRSOVs being arranged in series with the second pre-cooler.

According to another aspect of the invention, an aircraft is provided and includes a first side including a first turbine engine, a first pre-cooler sized to handle demands of one first downstream flow system and a first pair of dual pressure regulator shut off valves (PRSOVs) disposed in parallel with each other and between the first turbine engine and the first downstream flow system and in series with the first pre-cooler and a second side including a second turbine engine, a second pre-cooler sized to handle demands of one second downstream flow system and a second pair of dual PRSOVs disposed in parallel with each other and between the second turbine engine and the second downstream flow system and in series with the second pre-cooler.

According to yet another aspect of the invention, a method of designing an aircraft is provided and includes determining a size necessary for a pre-cooler to handle demands of one flow system of the aircraft, fitting first and second pre-coolers respectively sized in accordance with a result of the determination for installation into first and second sides of the aircraft, respectively and fitting first and second pairs of dual pressure regulator shut off valves (PRSOVs) for respective disposition in parallel with each other and between first and second turbine engines and first and second downstream flow systems, respectively, in series with the first and second pre-coolers, respectively.

These and other advantages and features will become more apparent from the following description taken in conjunction with the drawings.

### BRIEF DESCRIPTION OF THE DRAWINGS

The subject matter, which is regarded as the invention, is particularly pointed out and distinctly claimed in the claims at the conclusion of the specification. The foregoing and other features, and advantages of the invention are apparent from the following detailed description taken in conjunction with the accompanying drawings in which:

FIG. 1 is a schematic illustration of an aircraft in accordance with embodiments;

FIG. 2 is a schematic illustration of a dual PRSOV apparatus of an aircraft in accordance with embodiments; and

FIG. 3 is a flow diagram illustrating a method of operating a dual PRSOV apparatus of an aircraft in accordance with embodiments.

The detailed description explains embodiments of the invention, together with advantages and features, by way of example with reference to the drawings.

### DETAILED DESCRIPTION OF THE INVENTION

As will be described below, bleed system architecture of an aircraft or a similar vehicle is modified by the replacement of a single pressure regulating valve with two smaller pressure regulating valves arranged in parallel. These parallel valves increase the number of failures required before one side of the bleed system architecture is lost. As a result, the system can be dispatched with one PRSOV failure and still provide independent icing flow to each wing along with independent pack flow. This allows for pre-cooler sizing and overall weight of the bleed system architecture to be reduced.

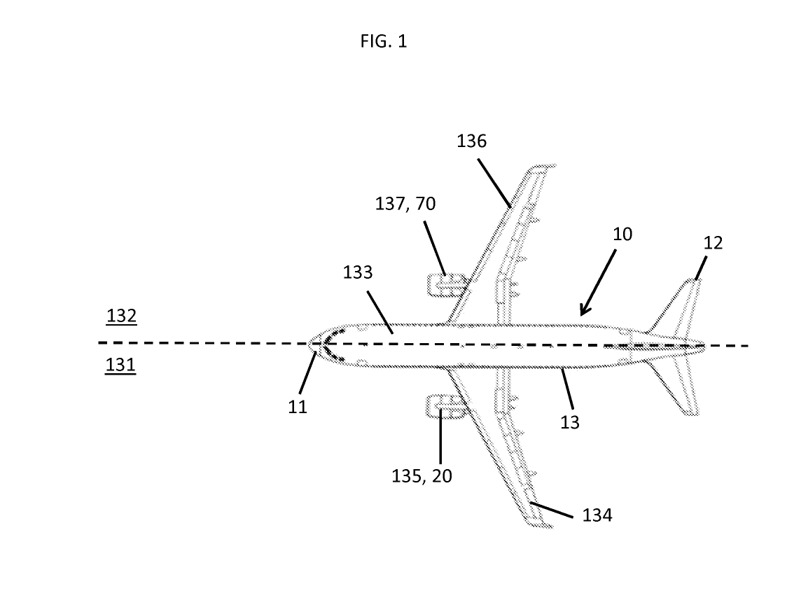

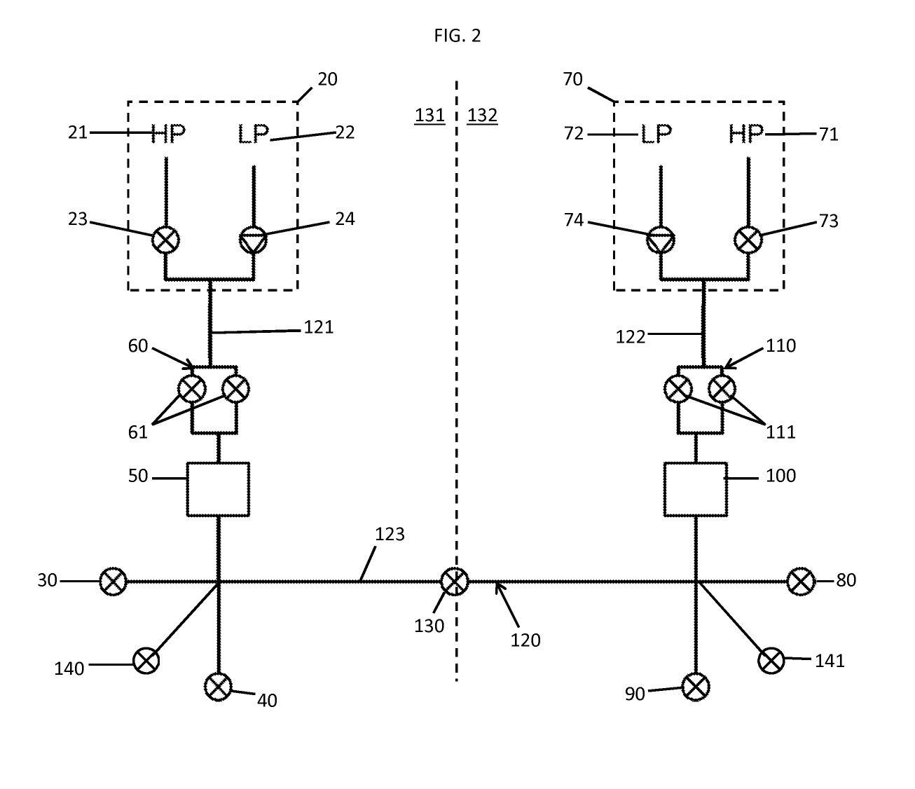

With reference to FIGS. 1 and 2, an aircraft 10 is provided and includes a nose 11 at a forward end thereof, a tail 12 at a trailing end thereof and fuselage 13 extending between the nose 11 and the tail 12. The fuselage 13 is dividable into a first (i.e., left) side 131 and a second (i.e., right) side 132 and includes a cabin portion 133, a first side wing 134 to which a first side engine nacelle 135 is coupled and a second side wing 136 to which a second side engine nacelle 137 is coupled.

The first side 131 of the aircraft 10 further includes a first turbine engine 20 supportively disposed in the first side engine nacelle 135, at least one of one first downstream anti-ice flow system 30 and one first downstream pack flow system 40, a first pre-cooler 50 sized to handle demands of at least one of one downstream anti-ice flow system and/or one downstream pack flow system and a first pair of dual pressure regulator shut off valves (PRSOVs) 60 arranged in series with the first pre-cooler 50. The second side 132 of the aircraft 10 further includes a second turbine engine 70 supportively disposed in the second side engine nacelle 137, at least one of one second downstream anti-ice flow system 80 and one second downstream pack flow system 90, a second pre-cooler 100 sized to handle demands of at least one of one downstream anti-ice flow system and/or one downstream pack flow system and a second pair of dual PRSOVs 110 arranged in series with the second pre-cooler 100.

The first pair of dual PRSOVs 60 is disposed in a parallel arrangement with each other and between the first turbine engine 20 and the first pre-cooler 50. Each of the first pair of dual PRSOVs 60 includes a two-way valve 61. Similarly, the second pair of dual PRSOVs 110 is disposed in a parallel arrangement with each other and between the second turbine engine 70 and the second pre-cooler 100. Each of the second pair of dual PRSOVs 110 includes a two-way valve 111.

As shown in FIG. 2, the aircraft 10 further includes a piping system 120. The piping system 120 includes first piping 121, second piping 122 and third piping 123. The first pair of dual PRSOVs 60 is disposed along the first piping 121 and the first piping 121 is thereby disposed such that the first pre-cooler 50 is receptive of compressed air from the first turbine engine 20 via the first pair of dual PRSOVs 60. The second pair of dual PRSOVs 110 is disposed along the second piping 122 and the second piping 122 is thereby disposed such that the second pre-cooler 100 is receptive of compressed air from the second turbine engine 70 via the second pair of dual PRSOVs 110. The third piping 123 is disposed to couple both of the first and second pre-coolers 50 and 100 to both (or either) of the first and second downstream anti-ice flow systems 30 and 80 and to both (or either) of the first and second downstream pack flow systems 40 and 90. A two-way valve 130 may be disposed along the third piping 123 between the first pre-cooler 50 and both (or either) of the second downstream anti-ice flow system 80 and the second downstream pack flow system 90. The two-way valve 130 is similarly disposed between the second pre-cooler 100 and both (or either) of the first downstream anti-ice flow system 30 and the first downstream pack flow system 40.

The aircraft 10 may further include first and second nitrogen gas systems 140 and 141. Both of the first and second pre-coolers 50 and 100 may be coupled to and sized to handle the additional demands of both (or either) of the first and second nitrogen gas systems 140 and 141 by way of the third piping 123.

With continued reference to FIG. 2, the first turbine engine 20 may include a high pressure compressor 21, a low pressure compressor 22, a two-way valve 23 and a check valve 24. The high pressure compressor 21 is configured to compress inlet air to a relatively high pressure (HP), whereby the HP compressed inlet air is then mixable with fuel for combustion in a combustor to produce a working fluid that is expanded in a turbine section to generate thrust. The low pressure compressor 22 is configured to compress inlet air to a relatively low pressure (LP), whereby the LP compressed inlet air is then mixable with the HP compressed inlet air and the fuel for the combustion.

The two-way valve 23 is disposed between the high pressure compressor 21 and the first pair of dual PRSOVs 60 to permit a flow of HP compressed air to the first pair of dual PRSOVs 60. The check valve 24 is disposed between the low pressure compressor 22 and the two-way valve 23 to permit a flow of LP compressed inlet air to the first pair of dual PRSOVs 60 but to prevent HP compressed inlet air from flowing to the low pressure compressor 22. The two-way valve 23 and the check valve 24 are thereby disposed to control an amount of compressed air that may be bled from the first turbine engine 20 for use in both (or either) of the first and second downstream anti-ice flow systems 30 and 80, both (or either) of the first and second downstream pack flow systems 40 and 90 and both (or either) of the first and second nitrogen gas systems 140 and 141 by way of the first pair of dual PRSOVs 60 and the first pre-cooler 50. In accordance with embodiments, the two-way valve 23 could be removed for a signal stage bleed system or replaced with several valves for a 3 or more port system.

The second turbine engine 70 may include a high pressure compressor 71, a low pressure compressor 72, a two-way valve 73 and a check valve 74. The high pressure compressor 71 is configured to compress inlet air to a relatively high pressure (HP), whereby the HP compressed inlet air is then mixable with fuel for combustion in a combustor to produce a working fluid that is expanded in a turbine section to generate thrust. The low pressure compressor 72 is configured to compress inlet air to a relatively low pressure (LP), whereby the LP compressed inlet air is then mixable with the HP compressed inlet air and the fuel for the combustion.

The two-way valve 73 is disposed between the high pressure compressor 71 and the second pair of dual PRSOVs 110 to permit a flow of HP compressed air to the second pair of dual PRSOVs 110. The check valve 74 is disposed between the low pressure compressor 72 and the two-way valve 73 to permit a flow of LP compressed inlet air to the second pair of dual PRSOVs 110 but to prevent HP compressed inlet air from flowing to the low pressure compressor 72. The two-way valve 73 and the check valve 74 are thereby disposed to control an amount of compressed air that may be bled from the second turbine engine 70 for use in both (or either) of the first and second downstream anti-ice flow systems 30 and 80, both (or either) of the first and second downstream pack flow systems 40 and 90 and both (or either) of the first and second nitrogen gas systems 140 and 141 by way of the second pair of dual PRSOVs 110 and the second pre-cooler 100. In accordance with embodiments, the two-way valve 73 could be removed for a signal stage bleed system or replaced with several valves for a 3 or more port system.

Embodiments in which the aircraft 10 includes the first and second downstream anti-ice flow systems 30 and 80 and the first and second downstream pack flow systems 40 and 90 will now be described further. As shown in FIG. 2, the compressed air bled from the first turbine engine 20 for use in meeting the demands of the first and second downstream anti-ice flow systems 30 and 80 and in meeting the demands of the first and second downstream pack flow systems 40 and 90, passes through the first pair of dual PRSOVs 60 prior to passing through the first pre-cooler 50. Under normal operating conditions, both of the two-way valves 61 are functional and can be partially opened such that the compressed air bled from the first turbine engine 20 can pass to the first pre-cooler 50. However, in a case in which one of the two-way valves 61 is non-functional, the other of the two-way valves 61 may be operated such that an amount of the compressed air bled from the first turbine engine 20 passing to the first pre-cooler 50 remains substantially constant. That is, if the non-functional one of the two-way valves 61 is stuck in the closed position, the other one of the two-way valves 61 can be fully opened. The two-way valves 111 of the second pair of dual PRSOVs 110 can be operated in a similar manner.

Since it is unlikely that both of the two-way valves 61 and both of the two-way valves 111 will be non-functional, both the first pre-cooler 50 and the second pre-cooler 100 will be supplied with compressed air bled from the first turbine engine 20 and the second turbine engine 70, respectively. As such, both the first and the second pre-coolers 50 and 100 will be able to cooperatively handle and meet the demands of both of the first and second downstream anti-ice flow systems 30 and 80 and both of the first and second downstream pack flow systems 40 and 90. Thus, the first pre-cooler 50 can be sized to handle and meet the demands of only one anti-ice flow system of the aircraft 10 and only one pack flow system of the aircraft 10 (since the second pre-cooler 100 can be relied upon to handle and meet the demands of the other flow systems) whereas the second pre-cooler 100 can also be sized to handle and meet the demands of only one anti-ice flow system of the aircraft 10 and only one pack flow system of the aircraft 10 (since the first pre-cooler 50 can be relied upon to handle and meet the demands of the other flow systems). This arrangement stands in contrast to configurations in which each pre-cooler is associated with only one PRSOV such that the failure of a PRSOV results in the inability of the associated pre-cooler to handle the demands placed on it and the requirement that the other pre-cooler be increased in size to handle the demands placed on both pre-coolers.

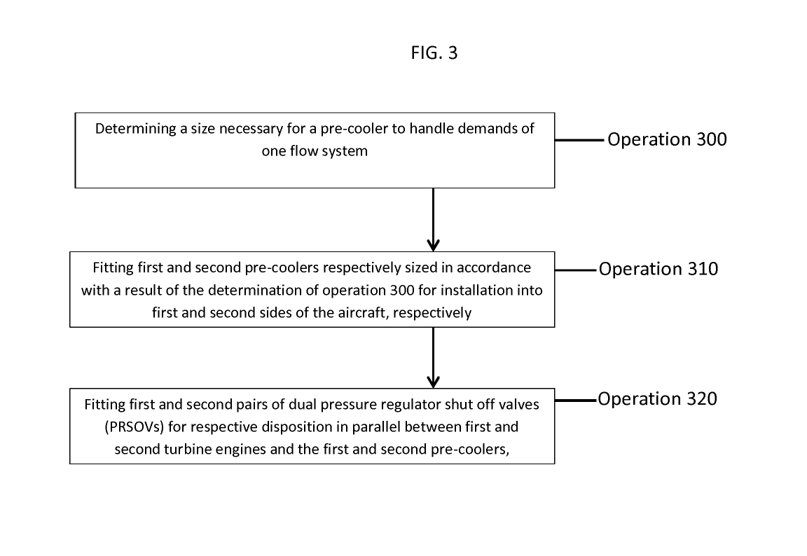

With reference to FIG. 3 and, in accordance with further aspects of the invention, a method of designing an aircraft is provided. As shown in FIG. 3, the method includes determining a size necessary for a pre-cooler to handle demands of one flow system of the aircraft (operation 300), fitting first and second pre-coolers respectively sized in accordance with a result of the determination of operation 300 for installation into first and second sides of the aircraft, respectively (operation 310) and fitting first and second pairs of dual pressure regulator shut off valves (PRSOVs) for respective disposition in parallel between first and second turbine engines and the first and second downstream flow systems, respectively (operation 320). In accordance with embodiments, the one flow system of the aircraft may include at least one of one anti-ice flow of the aircraft and one pack flow of the aircraft. In accordance with further embodiments, the one flow system of the aircraft may include at least one of one anti-ice flow of the aircraft, one pack flow of the aircraft and one nitrogen gas flow of the aircraft.

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the invention. Additionally, while various embodiments of the invention have been described, it is to be understood that aspects of the invention may include only some of the described embodiments. Accordingly, the invention is not to be seen as limited by the foregoing description, but is only limited by the scope of the appended claims.

What is claimed is:

1. A pre-cooler system, comprising:
first and second pre-coolers, each of which is sized to handle demands of one downstream flow system;
a piping system by which the first and second pre-coolers are receptive of compressed air from first and second turbine engines, respectively, and by which the first and second pre-coolers are both coupled to first and second downstream flow systems that are each configured to apply the demands of one downstream flow system to the first and second pre-coolers;
a first pair of dual pressure regulator shut off valves (PRSOVs) disposed in parallel with each other and between the first turbine engine and the first downstream flow system, arranged in series with the first pre-cooler; and
a second pair of dual PRSOVs disposed in parallel with each other and between the second turbine engine and the second downstream flow system, arranged in series with the second pre-cooler.

2. The pre-cooler system according to claim 1, wherein each of the first and second pairs of the dual PRSOVs comprises a two-way valve.

3. The pre-cooler system according to claim 1, wherein the piping system comprises:
first piping along which the first pair of dual PRSOVs is disposed by which the first pre-cooler is receptive of compressed air from the first turbine engine via the first pair of dual PRSOVs;
second piping along which the second pair of dual PRSOVs is disposed by which the second pre-cooler is receptive of compressed air from the second turbine engine via the second pair of dual PRSOVs; and
third piping by which the first and second pre-coolers are both coupled to the first and second downstream flow systems.

4. The pre-cooler system according to claim 3, wherein the first downstream flow system comprises at least one of one first downstream anti-ice flow system and one first downstream pack flow system and the second downstream flow system comprises at least one of one second downstream anti-ice flow system and one second downstream pack flow system.

5. The pre-cooler system according to claim 4, wherein the first downstream flow system further comprises one nitrogen gas system and the second downstream flow system further comprises one nitrogen gas system.

6. The pre-cooler system according to claim 3, further comprising a two-way valve disposed along the third piping.

7. The pre-cooler system according to claim 1, wherein the first turbine engine comprises:
a high pressure compressor;
a low pressure compressor;
a two-way valve disposed between the high pressure compressor and the first pair of dual PRSOVs; and
a check valve disposed between the low pressure compressor and the two-way valve.

8. The pre-cooler system according to claim 1, wherein the second turbine engine comprises:
a high pressure compressor;
a low pressure compressor;
a two-way valve disposed between the high pressure compressor and the second pair of dual PRSOVs; and
a check valve disposed between the low pressure compressor and the two-way valve.

9. An aircraft, comprising:
a first side including a first turbine engine, a first pre-cooler sized to handle demands of one first downstream flow system and a first pair of dual pressure regulator shut off valves (PRSOVs) disposed in parallel with each other and between the first turbine engine and the first downstream flow system and in series with the first pre-cooler; and
a second side including a second turbine engine, a second pre-cooler sized to handle demands of one second downstream flow system and a second pair of dual PRSOVs disposed in parallel with each other and between the second turbine engine and the second downstream flow system and in series with the second pre-cooler.

10. The aircraft according to claim 9, wherein each of the first and second pairs of the dual PRSOVs comprises a two-way valve.

11. The aircraft according to claim 9, further comprising a piping system, the piping system comprising:
first piping along which the first pair of dual PRSOVs is disposed and by which the first pre-cooler is receptive of compressed air from the first turbine engine via the first pair of dual PRSOVs;
second piping along which the second pair of dual PRSOVs is disposed and by which the second pre-cooler is receptive of compressed air from the second turbine engine via the second pair of dual PRSOVs; and
third piping by which the first and second pre-coolers are both coupled to the one first downstream flow system and the one second downstream flow system.

12. The aircraft according to claim 11, wherein the one first downstream flow system comprises at least one of one first downstream anti-ice flow system and one first downstream pack flow system and the one second downstream flow system comprises at least one of one second downstream anti-ice flow system and one second downstream pack flow system.

13. The aircraft according to claim 12, wherein the one first downstream flow system further comprises one first nitrogen gas system and the one second downstream flow system further comprises one second nitrogen gas system.

14. The aircraft according to claim 11, further comprising a two-way valve disposed along the third piping.

15. The aircraft according to claim 9, wherein the first turbine engine comprises:
a high pressure compressor;
a low pressure compressor;
a two-way valve disposed between the high pressure compressor and the first pair of dual PRSOVs; and
a check valve disposed between the low pressure compressor and the two-way valve.

16. The aircraft according to claim 9, wherein the second turbine engine comprises:
a high pressure compressor;
a low pressure compressor;
a two-way valve disposed between the high pressure compressor and the second pair of dual PRSOVs; and
a check valve disposed between the low pressure compressor and the two-way valve.

17. A method of designing an aircraft, comprising:
determining a size necessary for a pre-cooler to handle demands of one flow system of the aircraft;
fitting first and second pre-coolers respectively sized in accordance with a result of the determination for installation into first and second sides of the aircraft, respectively; and
fitting first and second pairs of dual pressure regulator shut off valves (PRSOVs) for respective disposition in parallel with each other and between first and second turbine engines and first and second downstream flow systems, respectively, in series with the first and second pre-coolers, respectively.

18. The method according to claim 17, wherein the one flow system of the aircraft comprises at least one of one anti-ice flow of the aircraft and one pack flow of the aircraft.

19. The method according to claim 17, wherein the one flow system of the aircraft comprises at least one of one anti-ice flow of the aircraft, one pack flow of the aircraft and one nitrogen gas flow of the aircraft.
